(19) United States
(12) Patent Application Publication
(10) Pub. No.: US 2018/0356799 A1
(43) Pub. Date: Dec. 13, 2018

(54) Method for the Simplified Modification of Application Programs for Controlling an Industrial Plant

(71) Applicant: KUKA Deutschland GmbH, Augsburg (DE)

(72) Inventor: Andreas Sedlmayr, Fürstenfeldbruck (DE)

(73) Assignee: KUKA Deutschland GmbH, Augsburg (DE)

(21) Appl. No.: 15/775,614

(22) PCT Filed: Nov. 9, 2016
(86) PCT No.: PCT/EP2016/001856

§ 371 Date: May 11, 2018

(30) Foreign Application Priority Data
Nov. 11, 2015 (DE) 102015222167.9

(51) Int. Cl. G05B 19/418

(52) U.S. Cl. CPC G05B 19/41835; B25J 9/1697

(57) ABSTRACT

The invention relates to a method for the simplified modification of application programs (2<sb/>, 3<sb/>) of an industrial plant (1<sb/>), comprising the following steps: (a) providing at least one application program (2<sb />, 3<sb/>) in an industrial plant (1), wherein the at least one application program (2<sb/>3<sb/>) has a plurality of program points (P1 to P5<sb />); (b) providing at least one graphical representation (101<sb/> to 103<sb/>), wherein the at least one graphical representation (101<sb /> to 103</>) shows at least one system state of the industrial plant (1<sb/>), wherein the system state corresponds to a program point (P1 to P5<sb/>) and the graphical representation (101 to 103) is linked to at least one program point (P1<sb/> to P5<sb/>) of the at least one application program (2<sb/>, 3<sb/>); (c) executing the application program (2<sb/>, 3<sb/>) and, if the application program stops, performing the fo11owing steps: (d) comparing the current system state of the industrial plant (1<sb/>) with the at least one graphical representation (101<sb/> to 103<sb/>) and (e) following a link between the graphical representation and a program point in order to modify the application program.

### FIELD OF THE INVENTION

The invention relates to a method for the simplified modification of application programs of an industrial plant, wherein in particular finding program points in the application program which are intended to be modified is simplified. Furthermore, the present invention relates to a computer program which makes it possible to execute the method by means of a computer or a microcontroller and to a device comprising a computer and/or a microcontroller configured to execute the computer program in accordance with the method.

### BACKGROUND

Application programs for controlling industrial plants typically consist of a juxtaposition of different execution steps, which execution steps can be varied by parameters. In this case, an execution step should be understood as a sub-unit of an operation of an industrial plant. By way of example, such an execution step can be the switching on or off of a part of the industrial plant, such as a welding torch, for example. An execution step can likewise define the movement of a movable part of the industrial plant. Movable parts can be for example linear axes, manipulators or generally actuators.

Execution steps are varied by parameters such as, for instance, (movement) coordinates, time indications, stipulations for forces and/or moments, temperature limits and the like. Particularly when setting up such an industrial plant it is necessary to vary the parameters and, if appropriate, also the juxtaposition of the individual execution steps.

In order to enable a flexible adaptation/optimization of an application program, the application program is typically created such that not just the original programmer is able to modify the application program, rather further trained persons are also authorized to make amendments.

An application program is typically created in a plurality of sections with the aid of a corresponding development environment. Once the program is at least partly executable—i.e. the application program is not yet complete and/or does not yet run without errors -, in the subsequent programing phase the parameters of the execution steps are optimized and, if appropriate, errors are detected and rectified. In this case, typically the real behavior of the industrial plant, i.e. the current system state of the industrial plant, is compared with the desired setpoint state. If amendments are intended to be made, such as, for example, a change in the parameters of an execution step, then it is necessary for the person who makes the modifications to recognize which execution step of the application program corresponds to the current system state of the industrial plant.

If the industrial plant, for example after an execution step, stops on account of an error that has occurred, the programmer has to recognize the program point of the application program which the industrial plant has currently reached, and to establish a reference to the corresponding program code point and/or the corresponding parameter set in order to make the necessary modifications there. This is sometimes a problem particularly in the case of java programs. As soon as an “exception” is triggered as a cause of an error, which then leads to the termination of the program, normally only a so-called “call stack” is available to the programmer, but not necessarily the program point that is the cause of the error.

In this case, the term program point denotes code points in the application program. In particular, a program point can identify a beginning and/or end point of an execution step. In order to recognize the program point that the industrial plant has presently reached, a considerable training effort is necessary. Moreover, the procedure described is susceptible to errors since it cannot be ensured that the corresponding program point is correctly recognized.

In order to solve the problem described, techniques are currently employed which are intended to improve the readability and the intuitive understanding of the program code. Said techniques comprise for example the graphical modeling of the application programs by semantic models and the like. Nevertheless, here as well there is the problem of correct and rapid assignment of a past and/or the current system state of the industrial plant to the corresponding program point of the application program or of the graphical model.

In principle, the problem described exists in all industrial plants and in particular during the initial start-up thereof and/or during the modification of process sequences. Typical industrial plants comprise at least one manipulator configured to interact physically with the environment. By way of example, such a manipulator may be an industrial robot that has at least three movable, freely programmable axes and guides an end effector, such as a gripper, for example. Such industrial plants are used in automobile manufacture, for example. If such an industrial plant is converted to the production of a new type of vehicle, then extensive modifications are necessary, which are often carried out with high expenditure of time and with high probability of errors in the prior art.

It is an object of the present invention to completely or partly eliminate the disadvantages described.

### SUMMARY

The object is achieved by means of a method as claimed in claim 1, a computer program as claimed in claim 16 and a device as claimed in claim 19. In particular, the object is achieved by means of a method for the simplified modification of application programs of an industrial plant, comprising the following method steps:
a) providing at least one application program on an industrial plant, wherein the at least one application program has a plurality of program points;
b) providing at least one graphical representation, wherein the at least one graphical representation shows at least one system state of the industrial plant, wherein the system state corresponds to a program point and the graphical representation is linked with at least one program point of the at least one application program;
c) executing the application program and, if the application program stops, executing the following method steps:
d) displaying the at least one graphical representation, and
e) finding a program point with which the graphical representation is linked, using a link between the graphical representation and a program point.

As described in the introduction, a program point preferably corresponds to a beginning and/or end point of an execution step of a application program. In this case, an execution step is a sub-unit of an operation of an industrial plant. By way of example, such an execution step can be the movement of a tool center point (TCP) of a manipulator of the industrial plant from a first point A to a second point B.

An application program is typically a high-level program which links together different execution steps of the industrial plant via program points and is clearly represented preferably in the form of a model, such as a graphical model, for instance. The at least one program point of the application program is linked with at least one graphical representation of the industrial plant. The graphical representation of the industrial plant can comprise an actual image, such as, for instance, a photograph or a video of the industrial plant, and also an abstracted representation. The graphical representation can likewise show only a part of the industrial plant that is characteristic of the corresponding program point. If the program point relates to the gripping of an object, for example, just the gripper can be represented.

The link of the at least one graphical representation with the corresponding program point makes it possible, by selecting the graphical representation, for example, to follow the link and thus directly to arrive at an editor that makes it possible to modify the application program at the corresponding program point. The selection can be carried out for example by means of a mouse click, a touch command, voice control, gesture control and/or the like.

Preferably, after displaying the at least one graphical representation, a past and/or the current system state of the industrial plant are/is compared with the at least one graphical representation and a link is selected.

In order that the correct link can be followed, in the event of the industrial plant stopping, a past or the current system state thereof is compared with the at least one graphical representation. The comparison of the system state of the industrial plant with the at least one graphical representation is preferably effected by an operator. If a graphical representation corresponds to the current system state of the industrial plant, then the link can be selected and it is possible to follow the link to the corresponding program point in the application program. Furthermore, the operator can compare a past system state that the operator recognized as erroneous with the at least one graphical representation in order to find the corresponding program point in the application program. It is likewise possible for the comparison to be performed automatically, for example by a current image of the industrial plant being recorded and compared with the graphical representation by machine. In this case, finding a program point with which the graphical representation is linked, using a link between the graphical representation and a program point, can be carried out in an automated manner and does not need intervention by an operator.

The comparison becomes necessary if e.g. the industrial plant stops, i.e. the execution of the application program is stopped. In this case, stopping of the industrial plant or of the application program can be forced manually by the operator, for example, or be brought about e.g. by an error in the industrial plant, resulting in the automatic intervention of a safety device.

The described link of graphical representation and program point makes it possible for an operator rapidly to find the corresponding program point and/or to call up a corresponding parameter set which is/are intended to be modified. Furthermore, this link makes it possible to significantly reduce the training effort of persons who are intended to alter or finalize application programs. Moreover, the error rate can be reduced since the relevant program points can be recognized rapidly and reliably. This increases the efficiency.

Preferably, the at least one graphical representation provided is linked with at least one program point of the at least one application program by means of the following method steps:
executing the at least one application program step by step, wherein the at least one application program is at least partly executable, wherein each execution step preferably begins and/or ends at a program point;
creating at least one graphical representation of at least one part of the industrial plant directly before, after or during the execution of an execution step;
linking the graphical representation created with the corresponding program point of the application program.

Preferably, the at least one application program is at least partly executable, such that the industrial plant can be controlled in accordance with the application program. The process of subsequently creating the at least one graphical representation is preferably carried out in an automated manner. By way of example, a graphical representation of the at least one industrial plant is created at each program point of the application program, or upon the program point being passed through during the execution of the application program. Likewise, linking the graphical representation created with the corresponding program point of the application program is preferably carried out in an automated manner. Consequently, firstly it is possible to ensure that the graphical representation is correctly assigned to the corresponding program point. Secondly it is insured that each program point is linked with a graphical representation.

Preferably, at least one region of a graphical representation is allocated a link with the corresponding program point of the application program, which region can be selected in order to follow the link. Preferably, the region is characteristic of the corresponding program point. By way of example, in the region it is possible to represent a point or a contour of a workpiece, the processing of which is concluded at the program point. Once a graphical representation has been created, then after the selection of a region it is possible to allocate to the region a link, preferably with the aid of a GUI. By selecting the region, for example by means of a touch command, a mouse click or the like, it is then possible to follow the link.

It is likewise possible for a graphical representation to be allocated a plurality of regions that are linked with different program points. By way of example, if a workpiece is represented in the graphical representation, then characteristic contours or points of the workpiece can be allocated different regions that are linked with corresponding program points via different links. Consequently, the number of graphical representations is reduced and the clarity and operability of the method are improved. Preferably, at least two, at least four, at least six or at least ten links and corresponding regions can be provided on a graphical representation.

If the graphical representation shows a workpiece, for example, wherein different regions are allocated to characteristic contours and/or points of the workpiece, i.e. are linked with different program points, then afterward a process result, such as a processed workpiece, for instance, can serve to compare current and/or past system states with the graphical representation and to find a desired program point. By way of example, if a welding process is intended to be set up and regionally poor weld seams are obtained, then on the basis of a comparison of a processed workpiece with the at least one graphical representation having different regions, it is possible to find that program point in the application program which is responsible for the poor weld seams.

Preferably, allocating a link to a region of a graphical representation is carried out by manual selection of the region, wherein the manual selection is preferably carried out by means of a drag-and-drop operation of a selectable button. In particular, the manual selection is carried out with the aid of a graphical user interface, GUI. By way of example, if a region of the graphical representation is characteristic of a program point, then a button comprising a link to the corresponding program point can be manually positioned in the corresponding region of the graphical representation. Preferably, the selectable button is visible in the graphical representation. However, it can also be present in a concealed manner, such that the region of the representation remains completely visible.

The manual selection of a region and the manual deposition of a selectable button make it possible to deposit further links with program points in a graphical representation. Preferably, allocating a link to a region of a graphical representation is carried out automatically, wherein during the capture of the at least one graphical representation, image marks are concomitantly captured, and wherein the image marks are fixedly assigned to a coordinate system of the industrial plant, such that the captured graphical representation can be brought to congruence with the coordinate system of the industrial plant. Image marks are typically characteristic points and/or contours of a workpiece which is positioned fixedly in relation to the industrial plant coordinate system. Image marks can likewise be characteristic points or contours of the environment. Furthermore, it is possible to provide autonomous image marks, such as are known from augmented reality applications, for example, at the industrial plant. Such image marks may be for example reflectors, color codes, LEDs, RFID tags and the like.

If the image marks are captured and the current system state of the industrial plant, such as a position of a manipulator, for example, can be described with reference to the image marks, then it is possible for a link to a corresponding program point to be automatically allocated to a region of a graphical representation. In order to automatically allocate the link, the captured graphical representation is brought to congruence with the industrial plant coordinate system by means of the image marks. If a specific coordinate point is assigned to an execution step or a program point, then said coordinate point can be displayed in the graphical representation and a corresponding region can be defined around said specific coordinate point. This reduces the time expenditure by comparison with the manual production of a link.

Preferably, the at least one graphical representation is a photograph of the industrial plant. Photographs are advantageous since they can easily be created and do not require further modeling of the industrial plant, such as would be necessary, for example, if only an abstracted representation of the industrial plant ought to be displayed in the graphical representation.

Preferably, the at least one graphical representation is a moving graphical representation of the industrial plant, wherein the moving graphical representation comprises a time axis, and wherein the moving graphical representation is linked with at least one program point of the at least one application program via a point in time on the time axis. A moving graphical representation can be for example a video of the industrial plant or an (animated) sequence of individual images. The assignment of individual program point to the moving graphical representation via a time axis enables a simple link of different program points with the moving graphical representation. Moreover, moving graphical representation are very easy to capture for an operator, as a result of which program point can be found more rapidly. Preferably, moving graphical representation of at least one part of the industrial plant are created during the execution of an execution step.

Preferably, at least two graphical representations are provided, wherein the at least two graphical representations are displayed in a list, which is preferably scrollable.

After the creation or recording of the graphical representations (recording mode), the graphical representations can be used for the simplified finding of program points in the application program (display mode). To that end, an operator causes the graphical representations to be displayed and compares them with the current system state of the industrial plant. Particularly in the case of small electrical displays, such as are provided for example on tablets or smartphones, only a limited number of graphical representations can be displayed simultaneously. In order nevertheless to enable a rapid comparison of the graphical representations with the current system state of the industrial plant, it is advantageous to display the individual images successively in a list. Scrolling through the list makes it possible to rapidly alternate the display of the individual graphical representations, such that the corresponding graphical representation which corresponds to the current system state of the industrial plant can be found rapidly.

Preferably, the application program stops if a stop is forced manually and/or if a safety device of the industrial plant issues a stop command. If the application program is not executed correctly, for example, then the operator can manually bring about a stop of the application program. The stop of the application program can likewise signify reaching the end of the application program. A stop command can likewise be brought about by a safety device of the industrial plant. This is typically the case when safety devices respond. The latter may be an emergency off switch, for example. Range monitoring may likewise intervene, such as, for example, speed monitoring, acceleration monitoring, force monitoring and/or moment monitoring or the like.

Preferably, finding a program point, using a link between the graphical representation and a program point, enables a modification of the at least one application program by virtue of the fact that for an operator a user interface is displayed, wherein parameters of the application program can be modified by means of the user interface. The user interface is preferably different than the mere display of the original program code of the application program. By way of example, the user interface can comprise a parameter list that allows individual parameters assigned to an execution step to be modified and/or optimized. Parameters may be either range parameters, such as, for instance, coordinates of a movement, force monitoring thresholds, moment monitoring thresholds and the like, or sequence parameters that influence the order of the execution steps. This is possible, for example, by varying the parameters assigned to a SWITCH or IF-ELSE instruction. Consequently, besides the actual execution steps, the order thereof in the application program can also be varied rapidly.

Preferably, finding a program point, using a link between the graphical representation and a program point, enables a modification of the at least one application program by virtue of the fact that for an operator an editor is displayed, wherein the editor preferably comprises a graphical model of the application program, and wherein modifications in the application program can be performed by means of the editor.

An editor that displays a graphical model of the application program enables a clear representation of the successive execution steps. The modification of the order of individual execution steps is thus simplified by means of an editor.

Preferably, the at least one link of the at least one graphical representation with the corresponding program point and/or the allocated region of the representation are/is updated automatically, in accordance with the modifications of parameters of the application program and/or in accordance with the modification of the application program. By way of example, if a characteristic point of a graphical representation which is allocated to a program point is varied by the modification of the parameters of the corresponding program point/corresponding execution step, then the region or the graphical representation itself can be directly adapted. This ensures that the graphical representations are always up-to-date and correspond to the corresponding application program.

Preferably, the at least one graphical representation is displayed on a control device of the industrial plant, wherein the control device is preferably a handheld control device, such as a tablet computer or a smartphone. If the graphical representation is displayed on a control device of the industrial plant, then it can be ensured that a comparison of the graphical representation and the industrial plant is directly possible since the control device is typically set up in the vicinity of the industrial plant. Moreover, the use of a tablet computer or a smartphone allows precisely said tablet computer or the smartphone to be employed universally and also a plurality of industrial plants to be configured with the same.

The object of the invention is additionally achieved by means of a computer program for the simplified modification of application programs of an industrial plant. In this case, the computer program comprises at least one interface to at least one application program of an industrial plant, wherein the at least one application program has a plurality of program points, and at least one graphical representation, wherein the at least one graphical representation shows at least one system state of the industrial plant, wherein the system state corresponds to a program point and the graphical representation is linked with at least one program point of the at least one application program.

Furthermore, the computer program comprises instructions which, when they are executed by a computer device or a computer system comprising a memory and a processor, cause the computer device or the computer system to execute the following steps:

displaying the at least one graphical representation for the purpose of comparing the current system state of the industrial plant with the at least one graphical representation; receiving a user input for selecting a graphical representation or a link between a graphical representation and a program point and following the link between the selected graphical representation and a program point or the selected link between a graphical representation and a program point in order to enable the user to modify the application program. The computer program makes it possible to execute the method as described above. Consequently, modifications in the application program can be executed more rapidly and are less susceptible to errors.

Preferably, the computer program furthermore comprises the following instructions:

instructions for executing the at least one application program step by step, wherein the at least one application program is at least partly executable, wherein each execution step preferably begins or ends at a program point;

instructions for capturing and storing at least one graphical representation of at least one part of the industrial plant directly before or after the execution of an execution step; and

instructions for linking the graphical representation captured with the corresponding program point of the application program.

The instruction for executing the application program step by step makes it possible, at each program point, to capture and to store a corresponding graphical representation. The link of the graphical representation with the corresponding program point is preferably effected via the interface provided by the computer program and/or the runtime environment thereof.

Preferably, the computer program furthermore comprises instructions for executing the method described above.

Furthermore, the object is achieved by means of a computer device or a computer system comprising a processor and a memory, configured for executing the computer program described above. Preferably, the computer device or the computer system is part of the industrial plant.

### BRIEF DESCRIPTION OF THE DRAWINGS

The invention is explained in greater detail below with reference to the appended figures, in which:

FIG. 1 shows an industrial plant;

FIG. 2 shows a model of the application program for controlling the industrial plant;

FIG. 3 shows a further model of the application program for controlling the industrial plant;

FIG. 4 shows a graphical representation of the industrial plant according to FIG. 1;

FIG. 5A shows a flow diagram of a method for linking a program point with a graphical representation, and

FIG. 5B shows a flow diagram of a method for the simplified modification of application programs for controlling an industrial plant.

### DETAILED DESCRIPTION

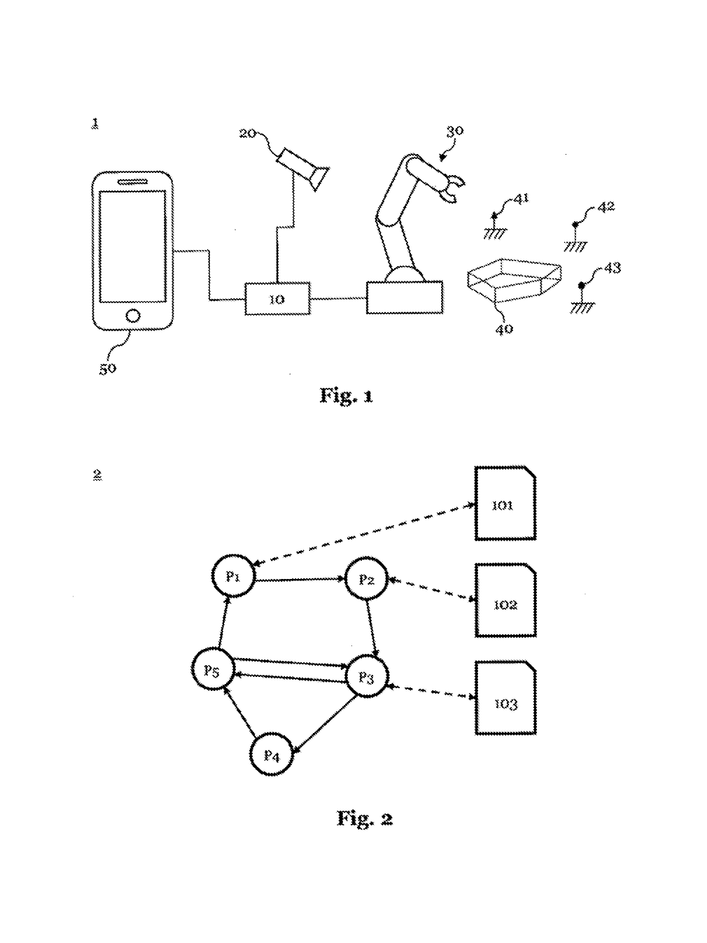

In particular, FIG. 1 shows an industrial plant 1 comprising a control device 10 configured to control the industrial plant 1. The industrial plant 1 is assigned a manipulator 30, for example, which is configured to process the workpiece 40. A recording device, such as a camera 20, for example, is configured to create graphical representations of the industrial plant or of parts of the industrial plant. An optical display device 50 is assigned to the control device 10 of the industrial plant 1.

The graphical representations mentioned in method claim 1 can be displayed on the optical display 50, which is for example a tablet computer or a smartphone. Likewise, the modifications of the application program of the industrial plant 1 can preferably be carried out on the graphical display 50. To that end, the optical display 50 can have a touch-sensitive screen or be provided with an external input device, such as a keyboard, for example. The image marks 41, 42, 43 make it possible to assign graphical representations captured by the camera 20 to the coordinate system of the industrial plant 1 via a projection matrix. Individual characteristic points of e.g. the workpiece 40 can thus be assigned to specific program points.

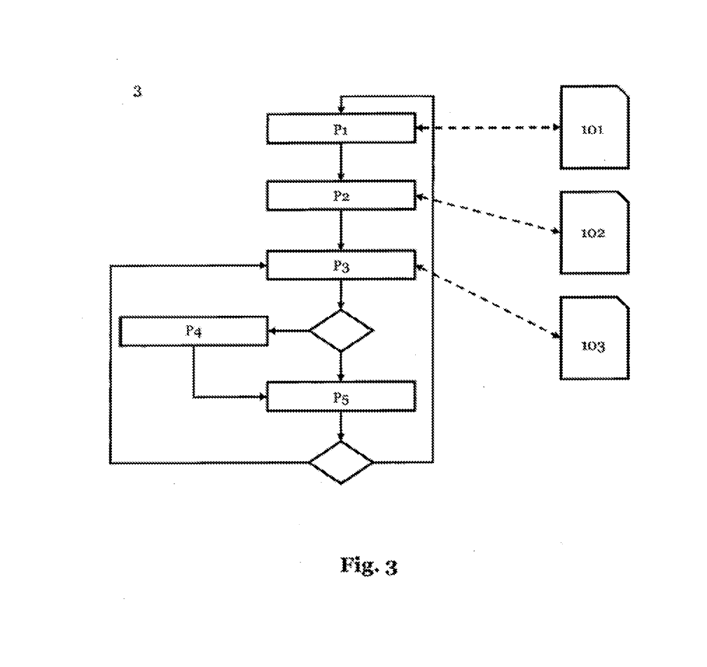

FIG. 2 shows a program model 2 of an application program for controlling an industrial plant 1. The individual execution steps are represented by arrows having a solid line. They are bounded by program points P1-P5. In the model shown in the present case, the program begins for example at program point P1 and ends at program point P5. By way of example, a manipulator can measure a workpiece at program point P1, begin the processing of the workpiece at program point P2 and conclude said processing at program point P3. Depending on the successful implementation, the program can be ended at P5 or the previous processing (see P1 to P3) can be corrected in execution steps via program point P4. Graphical representations 101, 102, 103 are assigned to the program points P1 to P3 and linked therewith. In principle, a dedicated graphical representation can be assigned to each program point. It is likewise possible for individual program points to be linked with no graphical representation or for a graphical representation to be linked with a plurality of program points. Regions enabling the program point to be unambiguously linked with the region of the graphical representation are preferably defined in this case.

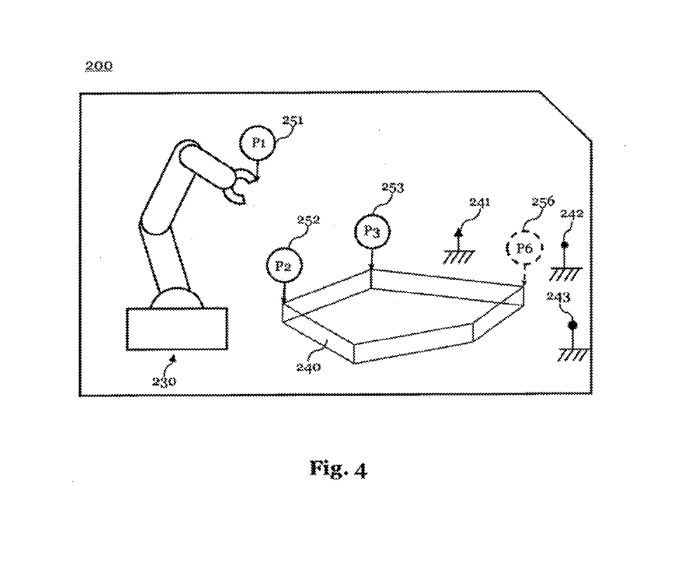

FIG. 3 shows the application program that was represented in FIG. 2 in a different representation. The reference signs correspond to one another. The representations shown in FIGS. 2 and 3 can be displayed in an editor, for example, if modifications to the application program are intended to be made.

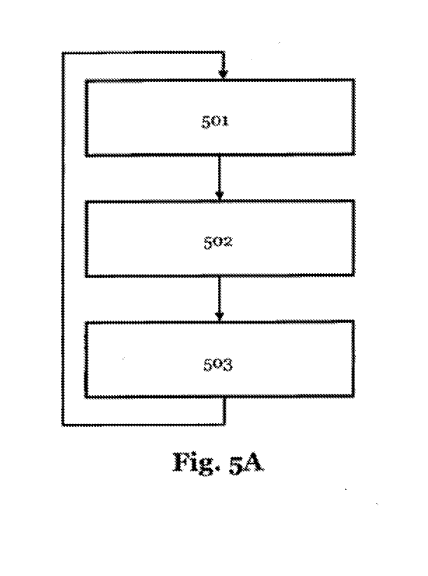

FIG. 4 shows a graphical representation 200 of an industrial plant. In particular, a part of the industrial plant which comprises a manipulator 230 and a workpiece 240 is represented. Specific regions of the graphical representation 251, 252, 253 are linked with the individual program points P1, P2, P3 of an application program. The image marks 241, 242, 243 enable the assignment of the graphical representation to a coordinate system of the manipulator. The region 256 can be linked for example with a further program point P6.

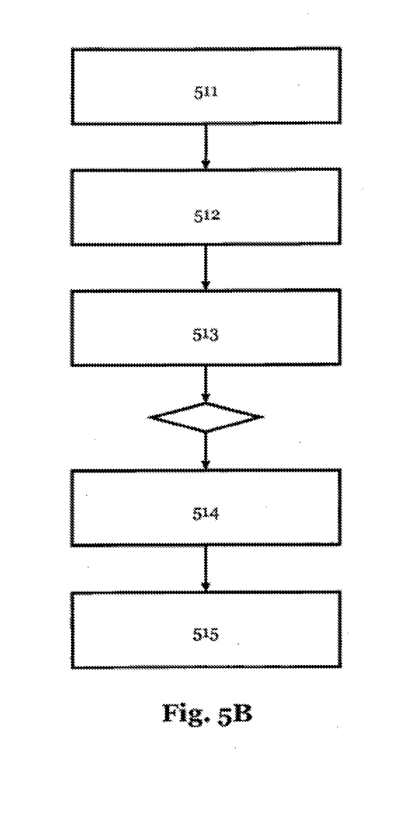

FIG. 5A shows a method for linking a program point with a graphical representation. In this case, in method step 501, the application program is executed step by step. In method step 502, at least one graphical representation of the industrial plant is captured and, in step 503, the captured graphical representation is linked with the corresponding program point of the application program. The method is preferably repeated until the application program has ended and a graphical representation has been assigned to each program point provided.

FIG. 5B shows a flow diagram of a method for the simplified modification of application programs for controlling industrial plants. In a first method step 511, at least one application program is provided on an industrial plant. In a second method step 512, at least one graphical representation is provided, wherein the at least one graphical representation shows at least one system state of the industrial plant. In execution step 513, the application program is executed and, if the latter stops, method steps 514 and 515 are executed. In method step 514, the current system state of the industrial plant is compared with the at least one graphical representation. In method step 515, the link between the graphical representation and a program point can be followed in order to modify the application program.

### LIST OF REFERENCE SIGNS

1 Industrial plant

10 Control device

20 Camera

30 Manipulator

40 Workpiece

50 Graphical display

41,42,43 Image marks

P1-P5 Program point

101,102,103,200 Graphical representations

230 Manipulator

240 Workpiece

241,242,243 Image marks

251,252,253,256 Regions, linked with program point

501 Executing the at least one application program step by step

502 Capturing at least one graphical representation

503 Linking the captured graphical representation with the corresponding program point

511 Providing at least one application program

512 Providing at least one graphical representation

513 Executing the application program

514 Comparing the current system state with the at least one graphical representation

515 Following a link between the graphical representation and a program point

What is claimed is:

1. A method for the simplified modification of application programs (2, 3) of an industrial plant (1), comprising the following method steps:
a) providing at least one application program (2, 3) on an industrial plant (1), wherein the at least one application program (2, 3) has a plurality of program points (P1 to P5);
b) providing at least one graphical representation (101 to 103; 200), wherein the at least one graphical representation (101 to 103; 200) shows at least one system state of the industrial plant (1), wherein the system state corresponds to a program point (P1 to P5) and the graphical representation (101 to 103) is linked with at least one program point (P1 to P5) of the at least one application program (2, 3);
c) executing the application program (2, 3) and, if the application program stops, executing the following method steps:
d) displaying the at least one graphical representation, and
e) finding a program point (P1 to P5) with which the graphical representation (101 to 103) is linked, using a link between the graphical representation (101 to 103) and a program point (P1 to P5).

2. The method as claimed in claim 1, wherein, after displaying the at least one graphical representation, a past and/or the current system state of the industrial plant (1) are/is compared with the at least one graphical representation (101 to 103; 200) and a link is selected.

3. The method as claimed in claim 1, wherein the at least one graphical representation (101 to 103; 200) provided is linked with at least one program point (P1-P5) of the at least one application program (2, 3) by means of the following method steps:
executing the at least one application program (2, 3) step by step, wherein the at least one application program (2, 3) is at least partly executable, wherein each execution step preferably begins or ends at a program point (P1 to P5);
creating at least one graphical representation (101 to 103; 200) of at least one part of the industrial plant (1) directly before, during or after the execution of an execution step;
linking the graphical representation (101 to 103; 200) created with the corresponding program point (P1 to P5) of the application program.

4. The method as claimed in, claim 1, wherein at least one region (251 to 253; 256) of a graphical representation (101 to 103; 200) is allocated a link with the corresponding program point (P1 to P5) of the application program (2, 3), which region can be selected in order to follow the link.

5. The method as claimed in claim 1, wherein allocating a link to a region (251 to 253; 256) of a graphical representation (101 to 103; 200) is carried out by manual selection of the region, and wherein the manual selection is preferably carried out by means of a drag-and-drop operation of a selectable button.

6. The method as claimed in claim 1, wherein allocating a link to a region (251 to 253; 256) of a graphical representation (101 to 103; 200) is carried out automatically, wherein
during the capture of the at least one graphical representation (101 to 103; 200), image marks (241, 242, 243) are concomitantly captured, and wherein
the image marks (241, 242, 243) are fixedly assigned to a coordinate system of the industrial plant (1), such that the captured graphical representation (101 to 103; 200) can be brought to congruence with the coordinate system of the industrial plant (1).

7. The method as claimed in claim 1, wherein the at least one graphical representation (101 to 103; 200) is a photograph of the industrial plant (1).

8. The method as claimed in claim 1, wherein the at least one graphical representation (101 to 103; 200) is a moving graphical representation of the industrial plant (1), wherein the moving graphical representation comprises a time axis, and wherein the moving graphical representation (101 to 103; 200) is linked with at least one program point (P1 to P5) of the at least one application program (2, 3) via a point in time on the time axis.

9. The method as claimed in claim 1, wherein at least two graphical representations (101 to 103; 200) are provided, and wherein the at least two graphical representations (101 to 103; 200) are displayed in a list, which is preferably scrollable.

10. The method as claimed in claim 1 wherein the application program (2, 3) stops if a stop is forced manually and/or if a safety device of the industrial plant (1) issues a stop command.

11. The method as claimed in claim 1, wherein finding a program point (P1 to P5), using a link between the graphical representation (101 to 103) and a program point (P1 to P5), enables a modification of the at least one application program (2, 3) by virtue of the fact that for an operator
a user interface is displayed, wherein parameters of the application program (2, 3) can be modified by means of the user interface.

12. The method as claimed in claim 1, wherein finding a program point (P1 to P5), using a link between the graphical representation (101 to 103) and a program point (P1 to P5), enables a modification of the at least one application program (2, 3) by virtue of the fact that for an operator
an editor is displayed, wherein the editor preferably comprises a graphical model of the application program (2, 3), and wherein modifications in the application program (2, 3) can be performed by means of the editor.

13. The method as claimed in claim 1, wherein the at least one link of the at least one graphical representation (101 to 103; 200) with the corresponding program point (P1 to P5) and/or the allocated region (251 to 253) are/is updated automatically, in accordance with the modification of parameters of the application program (2, 3) and/or in accordance with the modifications of the application program (2, 3).

14. The method as claimed in claim 1, wherein the industrial plant (1) comprises at least one manipulator (30).

15. The method as claimed in claim 1, wherein the at least one graphical representation (101 to 103; 200) is displayed on a control device of the industrial plant, wherein the control device is preferably a handheld control device, such as a tablet computer or a smartphone.

16. A computer program for the simplified modification of application programs (2, 3) of an industrial plant (1), comprising:
at least one interface to at least one application program (2, 3) of an industrial plant (1), wherein the at least one application program (2, 3) has a plurality of program points (P1 to P5);
at least one graphical representation (101 to 103; 200), wherein the at least one graphical representation (101 to 103; 200) shows at least one system state of the industrial plant (1), wherein the system state corresponds to a program point (P1 to P5) and the graphical representation (101 to 103) is linked with at least one program point (P1 to P5) of the at least one application program (2, 3);
wherein the computer program comprises instructions which, when they are executed by a computer device or a computer system comprising a memory and a processor, cause the computer device or the computer system to execute the following steps:
displaying the at least one graphical representation (101 to 103; 200) for the purpose of comparing the current system state of the industrial plant (1) with the at least one graphical representation (101 to 103; 200), and
receiving a user input for selecting a graphical representation or a link between a graphical representation (101 to 103) and a program point (P1 to P5);
following the link between the selected graphical representation (101 to 103) and a program point (P1 to P5) or the selected link between a graphical representation (101 to 103) and a program point (P1 to P5) in order to enable the user to modify the application program (2, 3).

17. The computer program as claimed in claim 16, furthermore comprising:
instructions for executing the at least one application program (2, 3) step by step, wherein the at least one application program (2, 3) is at least partly executable, wherein each execution step preferably begins or ends at a program point (P1 to P5);
instructions for capturing and storing at least one graphical representation (101 to 103; 200) of at least one part of the industrial plant (1) directly before or after the execution of an execution step;
instructions for linking the graphical representation (101 to 103; 200) captured with the corresponding program point (P1 to P5) of the application program.

18. (canceled)

19. A computer device or computer system comprising a memory and a processor, configured for executing the computer program as claimed in claim 16.
